(19) United States
(12) Patent Application Publication
(10) Pub. No.: US 2018/0282501 A1
(43) Pub. Date: Oct. 4, 2018

(54) GREEN TEA MEMORY FOAM AND ITS METHOD OF FABRICATING

(71) Applicant: Guobin Liu, Shenzhen (CN)

(72) Inventor: Guobin Liu, Shenzhen (CN)

(21) Appl. No.: 15/472,302

(22) Filed: Mar. 29, 2017

(51) Int. Cl. C08J 9/00; C08G 18/48; C08G 18/76; C08G 18/08

(52) U.S. Cl. CPC C08J 9/0014; C08J 9/0042; C08G 18/4804; C08G 2101/00; C08G 18/14; C08J 2375/08; C08G 18/7621

(57) ABSTRACT

A kind of green tea memory foam and its fabricating method comprises the following components at the weight ratio of 40˜45 percent of polyether polyol A, 25˜35 percent of polyether polyol B, 20˜30 percent of toluene diisocyanate, 1˜3 percent of green tea powder, 0.5˜2 percent of water, 0.01˜0.1 percent of silicone oil, 0.01˜0.03 percent of ammonia, 0.01˜0.03 percent of stannous octoate, and 0.005˜0.015 percent of mill base. The present invention belongs to the technical field of memory foam, particularly the memory foam with a fragrance of green tea which can effectively remove the unpleasant chemical smell with a natural smell of green tea to further improve the quality of sleep.

### FIELD OF THE INVENTION

The present invention belongs to the technical field of memory foam, particularly a kind of green tea memory foam and its method for fabricating.

### BACKGROUND OF THE INVENTION

Memory foam is a kind of memory material with feature of viscoelasticity and capable of temperature-response, wherein the air inside can flow freely. The shape of the foam has a memory ability of shape that it can changes along with the body silhouette during the change of pressure and temperature to have an effect of absorbing pressure and to mitigate the force bearing point and no sense of pressure accumulation or stabbing pain. Currently there are many memory foam products in the market, but the traditional memory foam products are mostly simple polyurethane material with unpleasant smell which is not conducive to human health. Therefore a kind of memory foam with fresh and natural smell as well as its method for fabricating needs to be researched.

### SUMMARY OF THE INVENTION

In order to solve the existing problem above-mentioned, the first purpose of the present invention is to provide a kind of memory foam with a fragrance of green tea which can effectively remove the unpleasant chemical smell by a natural smell of green tea to further improve the quality of sleep. The second purpose of the present invention is to provide a fabricating method for the green tea memory foam which is easy and feasible, suitable for large-scale production.

To achieve the first purpose above, the present invention adopts the following technical solutions: a kind of green tea memory foam comprising the following components at the weight ratio of 40˜45 percent of polyether polyol A, 25˜35 percent of polyether polyol B, 20˜30 percent of toluene diisocyanate, 1˜3 percent of green tea powder, 0.5˜2 percent of water, 0.01˜0.1 percent of silicone oil, 0.01˜0.03 percent of ammonia, 0.01˜0.03 percent of stannous octoate, and 0.005˜0.015 percent of mill base.

Further, a kind of green tea memory foam comprising the following components at the weight ratio of 43 percent of polyether polyol A, 29.08 percent of polyether polyol B, 24.5 percent of toluene diisocyanate, 2.2 percent of green tea powder, 1.1 percent of water, 0.06 percent of silicone oil, 0.025 percent of ammonia, 0.025 percent of stannous octoate, and 0.01 percent of mill base.

Further, the hydroxyl value of the said polyether polyol A is 32˜60 mgKOH/g.

Further, the hydroxyl value of the said polyether polyol B is 295˜315 mgKOH/g.

To achieve the second purpose above, the present invention adopts the following technical solutions:
1) Taking every component according to the weight ratio;
2) Mixing uniformly the polyether polyol A, polyether polyol B green tea powder and mill base according to the ratio for standby application;
3) Adding the water, silicone oil, ammonia and stannous octoate according to the ratio into the mixture of procedure 2) then mixing uniformly for standby application;
4) Adding the toluene diisocynate according to the ratio into the mixture of procedure 3) then mixing uniformly and quickly for 4˜6 seconds to get a new mixture;
5) Pouring the mixture of procedure 4) into a mold for foaming to foam into an intermediate green tea memory foam then taking it out from the mold after 10˜20 minitues, and then airing it for 20˜30 hours to get the green tea memory foam.

Adopting the above mentioned technical solution, the following beneficial effects of the invention is achieved: the product of the present invention is to add the green tea powder into the memory foam and no waste gas, waste water or industrial residue will be generated during the production process which belongs to non-pollution production since the green tea powder comes from the scrap materials of green tea. The memory foam products containing green tea powder take full advantage of the fresh aroma of green tea to provide people healthy and environmental household articles to protect the human health.

### DETAILED DESCRIPTION OF PREFERRED EMBODIMENTS

The technical solutions of the embodiments will be described clearly and completely. Obviously, the embodiments are just a part not all of the implementations. Based on the implementations of the present invention, the other implementations obtained by those skilled in the art without creative work will all fall within the scope of the invention.

Embodiment 1, a kind of green tea memory foam comprises the following components at the weight ratio of 43 percent of polyether polyol A, 29.08 percent of polyether polyol B, 24.5 percent of toluene diisocyanate, 2.2 percent of green tea powder, 1.1 percent of water, 0.06 percent of silicone oil, 0.025 percent of ammonia, 0.025 percent of stannous octoate, and 0.01 percent of mill base.

A fabricating method for the green tea memory foam comprises the following procedures:
1) Taking every component according to the weight ratio;
2) Mixing uniformly the polyether polyol A, polyether polyol B green tea powder and mill base according to the ratio for standby application;
3) Adding the water, silicone oil, ammonia and stannous octoate according to the ratio into the mixture of procedure 2) then mixing uniformly for standby application;
4) Adding the toluene diisocynate according to the ratio into the mixture of procedure 3) then mixing uniformly and quickly for 4˜6 seconds to get a new mixture;
5) Pouring the mixture of procedure 4) into a mold for foaming to foam into an intermediate green tea memory foam then taking it out from the mold after 10˜20 minitues, and then airing it for 20˜30 hours to get the green tea memory foam.

Embodiment 2, a kind of green tea memory foam comprises the following components at the weight ratio of 41 percent of polyether polyol A, 30 percent of polyether polyol B, 25 percent of toluene diisocyanate, 2 percent of green tea powder, 1.9 percent of water, 0.05 percent of silicone oil, 0.02 percent of ammonia, 0.02 percent of stannous octoate, and 0.01 percent of mill base.

A fabricating method for the green tea memory foam comprises the following procedures:
1) Taking every component according to the weight ratio;
2) Mixing uniformly the polyether polyol A, polyether polyol B green tea powder and mill base according to the ratio for standby application;
3) Adding the water, silicone oil, ammonia and stannous octoate according to the ratio into the mixture of procedure 2) then mixing uniformly for standby application;
4) Adding the toluene diisocynate according to the ratio into the mixture of procedure 3) then mixing uniformly and quickly for 4˜6 seconds to get a new mixture;
5) Pouring the mixture of procedure 4) into a mold for foaming to foam into an intermediate green tea memory foam then taking it out from the mold after 10˜20 minitues, and then airing it for 20˜30 hours to get the green tea memory foam.

Embodiment 3, a kind of green tea memory foam comprises the following components at the weight ratio of 45 percent of polyether polyol A, 29 percent of polyether polyol B, 22 percent of toluene diisocyanate, 1.9 percent of green tea powder, 2 percent of water, 0.05 percent of silicone oil, 0.03 percent of ammonia, 0.015 percent of stannous octoate, and 0.015 percent of mill base.

A fabricating method for the green tea memory foam comprises the following procedures:
1) Taking every component according to the weight ratio;
2) Mixing uniformly the polyether polyol A, polyether polyol B green tea powder and mill base according to the ratio for standby application;
3) Adding the water, silicone oil, ammonia and stannous octoate according to the ratio into the mixture of procedure 2) then mixing uniformly for standby application;
4) Adding the toluene diisocynate according to the ratio into the mixture of procedure 3) then mixing uniformly and quickly for 4˜6 seconds to get a new mixture;
5) Pouring the mixture of procedure 4) into a mold for foaming to foam into an intermediate green tea memory foam then taking it out from the mold after 10˜20 minitues, and then airing it for 20˜30 hours to get the green tea memory foam.

The green tea memory foam of the present invention has a color of green tea and the preservation time of the green tea aroma can be more than 6 months, mainly used for healthy sleep and rest. The main products of the present invention include bedding articles, pillows, mattresses, waist pillows, cushions; car accessories, seat cushions, back cushions, headrests and so on. The green tea memory foam of the invention has the advantages of effectively improving the environmental quality of the human body in the rest and sleep with fragrant smell, which highly satisfies the customers.

The detailed description above is just the embodiments of the present invention and not to limit the patent scope of the invention. All the equivalent structures and process modifications based on the specification of the present invention as well as the applications directly or indirectly in the other relevant technical field should also fall within the scope of the invention.

1. A kind of green tea memory foam comprising the components at the weight ratio of 40˜45 percent of polyether polyol A, 25˜35 percent of polyether polyol B, 20˜30 percent of toluene diisocyanate, 1˜3 percent of green tea powder, 0.5˜2 percent of water, 0.01˜0.1 percent of silicone oil, 0.01˜0.03 percent of ammonia, 0.01˜0.03 percent of stannous octoate, and 0.005˜0.015 percent of mill base.

2. The green tea memory foam of claim 1, further comprising the following components at the weight ratio of 43 percent of polyether polyol A, 29.08 percent of polyether polyol B, 24.5 percent of toluene diisocyanate, 2.2 percent of green tea powder, 1.1 percent of water, 0.06 percent of silicone oil, 0.025 percent of ammonia, 0.025 percent of stannous octoate, and 0.01 percent of mill base.

3. The green tea memory foam of claim 1, wherein the hydroxyl value of the said polyether polyol A is 32˜60 mgKOH/g.

4. The green tea memory foam of claim 1, wherein the hydroxyl value of the said polyether polyol B is 295˜315 mgKOH/g.

5. A fabricating method for green tea memory foam comprising the procedures as below:
1) Taking every component according to the weight ratio;
2) Mixing uniformly the polyether polyol A, polyether polyol B, green tea powder and mill base according to the ratio for standby application;
3) Adding the water, silicone oil, ammonia and stannous octoate according to the ratio into the mixture of procedure 2) then mixing uniformly for standby application;
4) Adding the toluene diisocynate according to the ratio into the mixture of procedure 3) then mixing uniformly and quickly for 4˜6 seconds to get a new mixture;
5) Pouring the mixture of procedure 4) into a mold for foaming to foam into an intermediate green tea memory foam then taking it out from the mold after 10˜20 minitues, and then airing it for 20˜30 hours to get the green tea memory foam.
